(19) United States
(12) Patent Application Publication
(10) Pub. No.: US 2004/0237410 A1
(43) Pub. Date: Dec. 2, 2004

(54) Power window for a vehicle

(76) Inventors: Patrice Cardine, Orleans (FR); Denis Chevy, Neuvy En Sullias (FR)

Correspondence Address: CARLSON, GASKEY & OLDS, P.C., 400 WEST MAPLE ROAD, SUITE 350, BIRMINGHAM, MI, 48009, US

(21) Appl. No.: 10/848,552

(22) Filed: May 18, 2004

(30) Foreign Application Priority Data
May 20, 2003 (FR) 03 06 048

(51) Int. Cl. E05F 11/48

(52) U.S. Cl. 49/352

(57) ABSTRACT

A vehicle window regulator includes a window glass support plate, a slide member driving the window glass support plate, a slideway for guiding the slide member, and a play take-up member for taking up play between the slide member and the slideway. The play take-up member is arranged between the window glass support plate and the slideway. The window regulator can be provided in a vehicle to improve the rigidity of a rear side window glass mounted in a cantilevered fashion and prevent the unsupported half-open window glass from swinging outwardly due to aerodynamic forces.

### REFERENCE TO RELATED APPLICATIONS

This application claims priority to French Patent Application FR 03 06 048 filed on May 20, 2003.

### TECHNICAL FIELD

The present invention relates to a power window or window regulator for a vehicle.

### BACKGROUND OF THE INVENTION

The Peugeot 206CC has a Cabriolet-type vehicle rear side window regulator device. The regulator device includes a panel and a slider plate to which a rear side window glass is secured. The slider plate is driven linearly along a slideway on the panel. The slider plate is guided linearly along the slideway via two slide members located at different heights. Each slide member has a spring member that takes up play between the slider plate and the panel. The spring members are on a side of the panel facing the inside of the vehicle.

A disadvantage is that this device does not provide sufficient rigidity in a direction transverse to the direction of vehicle movement. In particular, when the vehicle is moving, the device is not rigid enough to overcome the aerodynamic forces that tend to draw the window glass toward the outside of the vehicle. The top edge of the window glass, which is held in cantilevered fashion by the window regulator, has a tendency to swing and carry the upper slide member with it. This applies stress on the spring member of the upper slide member, making it unable to prevent the slider plate from moving away from the panel under the effect of aerodynamic forces. As a result, when the window glass is being closed, and in particular while the vehicle is moving, the top edge of the window glass is not suitably guided into roof seals.

There is consequently a need for a window regulator that prevents such deformation and offers greater rigidity.

### SUMMARY OF THE INVENTION

The present invention provides a vehicle window regulator including a window glass support plate, a slide member for driving the window glass support plate, a slideway for guiding the slide member, and a single play take-up member that takes up play between the slide member and the slideway. The play take-up member is arranged between the window glass support plate and the slideway.

Preferably, the slide member includes two jaws that embrace the slideway. The two jaws are preferably urged towards each other by the play take-up member and preferably match the shape of the slideway in a direction transverse to a length of the slideway.

In one embodiment, the slide member includes a pin that extends through a slot in the slideway. The two jaws are slidable along with the pin at each side of the slideway. Preferably, the play take-up member is a spring that is coaxial with the pin.

In one embodiment, the window lifter further includes a second slide member for driving the window glass support plate. The window lifter can include a second slideway for guiding the second slide member and a second play take-up member located between the second slideway and the second slide member. The first-mentioned slideway and this second slideway are preferably in the same plane, and the play take-up members are each located the same side of the plane.

A vehicle can be fitted with the window regulator of the present invention. Preferably, the first slide member is located above the second slide member.

### BRIEF DESCRIPTION OF THE DRAWINGS

Other characteristics and advantages of the invention will become clearer from the detailed description which follows of some embodiments of the invention provided solely by way of example and with reference to the attached drawings.

FIG. 1 schematically illustrates a perspective view of a window regulator;

FIG. 2 schematically illustrates a cross-sectional view taken along line A-A of FIG. 1; and

FIG. 3 schematically illustrates a diagrammatic view of the profile of the window regulator of FIG. 1.

### DETAILED DESCRIPTION OF PREFERRED EMBODIMENTS

The present invention provides a power window or window regulator including a window glass support plate and a slide member for driving the window glass support plate. The slide member is guided by a slideway. A single play take-up member takes up play between the slide member and the slideway, and is located between the window glass support plate and the slideway. Thus, the play take-up member is not stressed when stress that is applied on the window glass support plate moves the window glass support plate away from the panel. This increases the rigidity of the window regulator, in particular toward the outside of the vehicle. That is, in a direction transverse to the direction of vehicle movement.

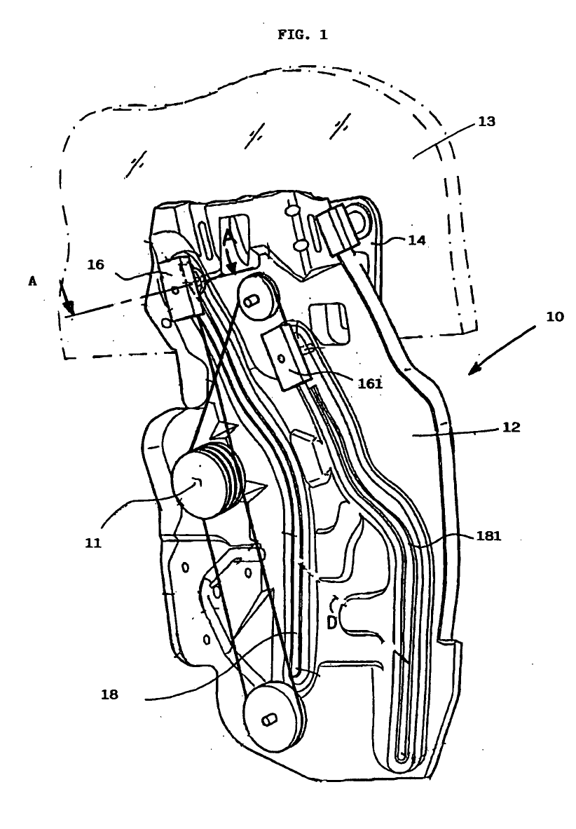

FIG. 1 is a perspective view of a window regulator 10. The window regulator 10 includes a window glass support plate 14 that supports a window glass 13. The window glass support plate 14 is driven by a slide member 16 shifted by a drive system 11. By way of example, FIG. 1 shows the drive system 11 including a cable, direction-changing pulleys and a drive drum. The drive system 11 is known, and therefore additional details of the drive system 11 will not be discussed. The slide member 16 is guided by a guiding slideway 18. Movement of the slide member 16 along the slideway 18 moves the window glass support plate 14 to lift or lower the window glass 13.

For example, the window regulator 10 enables a rear side window of an automobile vehicle (notably of the Cabriolet or coupe type) to be operated. The rear window in this type of vehicle is not guided by side channels over the entire distance between the open position and the closed position. Instead, the window glass 13 is cantilevered and held in the lower portion by the window regulator 10.

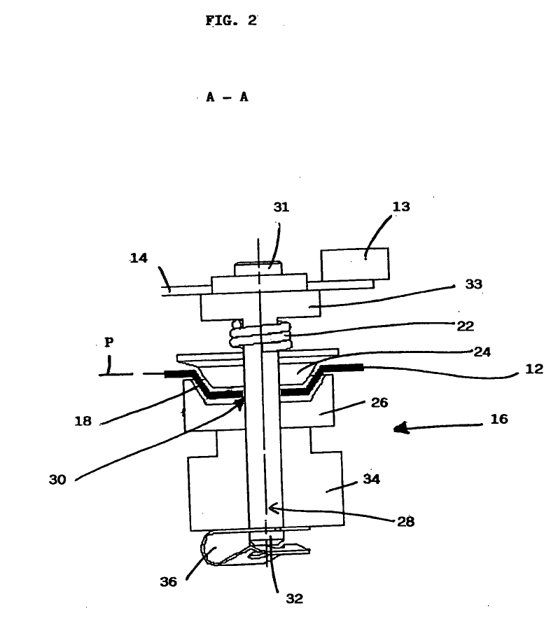

FIG. 2 is a sectional view taken along A-A of FIG. 1 showing a more detailed view of the slide member 16. The slide member 16 drives the window glass support plate 14, and the slide member 16 is guided in the slideway 18. The slideway 18 can be provided in a panel 12. The panel 12 is, for example, designed to be secured onto the vehicle bodywork and provides a support on which the complete window regulator 10 can be mounted to provide greater rigidity than a guide rail. When positioned in the vehicle, one side of the panel 12 occupied by the window glass support plate 14 faces the outside of the vehicle, and the other side of the panel 12 faces the inside of the vehicle.

The window regulator 10 carries a play take-up member 22 for taking up play between the slide member 16 and the slideway 18. The play take-up member 22 only takes up play between the slide member 16 and the slideway 18. In particular, the play take-up member 22 allows play appearing at the time of assembly (production tolerance) to be taken up, along with the play between the slide member 16 and the slideway 18 (operating wear). The play take-up member 22 is located between the window glass support plate 14 and the slideway 18. The play take-up member 22 does not extend further than the slideway 18, i.e. in the direction of the slideway 18 opposed to the side directed toward the window glass support plate 14.

The geometry of the slideway 18 determines the path of the window glass 13 when the window glass 13 is raised and lowered. The geometry typically allows the window glass 13 to be lowered vertically or to be lowered while undergoing a rotational movement (in combination with the slideway 181 as described below). FIG. 2 shows the panel 12 and the slideway 18 in a sectional view. The panel 12 extends along a mean plane P arranged substantially vertically in the vehicle bodywork. The slideway 18 is a recess in the mean plane P. The recess improves guiding of the slide member 16 along the panel 12. The slideway 18 can have sides extending in planes substantially perpendicular to the mean plane P. Alternatively, the sides of the slideway 18 can extend on inclined planes to give the slideway 18 a frusto-conical cross-section. The inclined planes open out from the base of the slideway 18 towards the mean plane P to form a dished section. The frusto-conical cross-section of the slideway 18 in the panel 12 provides better centering of the slide member 16 within the slideway 18, improving guiding of the slide member 16 in the slideway 18.

The slideway 18 can include a slot 30 formed through the panel 12 and extending substantially along the entire length of the slideway 18. The slot 30 is formed in the base of the slideway 18 and allows the slide member 16 to extend through the panel 12, making it possible to arrange the window glass support plate 14 at one side of the panel 12 and to arrange the drive system 11 at the other side of the panel 12. The slot 30 allows the slide member 16 to slide from one end of the slideway 18 to the other. The slide member 16 drives the window glass support plate 14 at one side of the panel 12, and the drive system 11 drives the window glass support plate 14 from the other side of the panel 12.

The slide member 16 drives the window glass support plate 14 and the window glass 13. As shown in FIG. 2, the slide member 16 extends at both sides of the slideway 18 through the slot 30. The slide member 16 includes a pin 28 extending through the slot 30 that transmits motion from the drive system 11 to the window glass support plate 14. One end 32 of the pin 28 of the slide member 16 is connected to the drive system 11 by, for example, a cross-member 34. The slide member 16 is connected with the drive system 11 in a conventional manner. The slide member 16 is connected at the other end 31 of the pin 28 to the window glass support plate 14 for the window glass 13. A shoulder 33 can be provided adjacent to the end 31 of the pin 28 for the window glass supporting plate 14. The window glass support plate 14 can be held against the shoulder 33 by rivets or by a screw introduced through the end 31 of the pin 28. The window glass support plate 14 can also be integrated with the slide member 16.

The slide member 16 can also include jaws 24 and 26 that embrace the slideway 18. The jaws 24 and 26 are located on both sides of the panel 12 to steady the movement of the slide member 16 in a direction transverse to the panel 12. In cross-section, the shape of the slideway 18 matches the shape of the jaws 24 and 26, improving the location of the slide member 16 along the slideway 18. Thus, the slide member 16 carries a male jaw 24 and a female jaw 26. In FIG. 2, the cross section of the slideway 18 is shown frusto-conical, and the jaws 24 and 26 have frusto-conical cross-sections. The male jaw 24 is formed by a runner having opposing sloping sides and is shaped to allow the male jaw 24 to fit into the dish defined by the sloping sides of the slideway 18. The female jaw 26 is correspondingly formed by a runner having a recess with sloping sides. The sloping sides of the female jaw 26 embrace the opposite face of slideway 18 and are applied against the matching sloping sides of the slideway 18. By employing a slideway 18 with a frusto-conical cross-section, the slide member 16 can be centered with respect to the slideway 18 and with respect to the slot 30. The female jaw 26 co-operates with the male jaw 24 to ensure stability of the slide member 16 along the slideway 18.

The jaws 24 and 26 are urged toward each other by the play take-up member 22, providing sliding contact between the jaws 24 and 26 and the panel 12. The play take-up member 22 can be a spring member coaxial with the pin 28, such as a spring.

The slide member 16 shown in FIG. 2 can be mounted through the panel 12 in the following order. The end 32 of the pin 28 is introduced successively through the play take-up member 22, the male jaw 24, the slot 30 of the panel 12, and then the female jaw 26. The pin 28 is optionally integral with the shoulder 33. The jaws 24 and 26 are slidable along the slideway 18 to provide the up-and-down motion of the window glass support plate 14. The end 32 of the pin 28 can then be introduced into the cross-member 34 to provide a connection with the drive system 11. The cross-member 34 is then pushed in towards the end 31 of the pin 28 by exercising force on the play take-up member 22. A circlip 36 can be fitted on the end 32 of the pin 28. The circlip 36 and the shoulder 33 prevent all the various elements from moving in translation. The play take-up member 22 is now maintained under tension, allowing play from assembly and wear of the various components to be taken up. The play take-up member 22 urges the jaws 24 and 26 sliding along the pin 28 towards each other and ensures sliding contact between the slide member 16 and the slideway 18.

When the vehicle is moving, aerodynamic effects tend to pull the window glass 13 towards the outside of the vehicle, also pulling successively in this direction on the window glass support plate 14 and on the slide member 16 by the end 31 of the pin 28. The parts located between the panel 12 and the end 32 of the pin 28 are now urged toward the panel 12 by the action of the pin 28. The parts between the panel 12 and the end 32 of the pin 28 form a rigid stop for the slide member 16. The play take-up member 22 is not subject to any force because it is on the other side of the panel 12. Now, the slide member 16 can not be driven in translation along with the window glass support plate 14, making it possible to overcome the aerodynamic effect. Thus, the distance between the panel 12 and the window glass support plate 14 remains unchanged when aerodynamic forces tend to move the window glass support plate 14 and window glass 13 away from the panel 12. This makes it possible to provide the window regulator 10 with greater rigidity in a direction transverse to the direction of vehicle movement toward the outside of the vehicle.

Thus, the window regulator 10 restrains the window glass 13 against deformation toward the outside of the vehicle, allowing the top edge of the window glass 13 to fit appropriately into the vehicle roof seal. Further, the present invention also has the advantage of making the upper or closed position of the window glass 13 repeatable.

FIG. 1 shows a window regulator 10 having a second slide member 161 for the window glass support plate 14. Note that the characteristics concerning the description of the slide member 16 that are encountered again in the description of the second slide member 161 are identified by the same reference numerals followed by a “1”. The presence of the second slide member 161 provides better stability for the window glass support plate 14 with respect to the panel 12. The window regulator 10 includes a second slideway 181 for guiding the second slide member 161. The geometry of the two slideways 18 and 181 makes it possible to impose a particular movement, such as a swinging movement, on the window glass 13 when the window glass 13 is lowered. The window regulator 10 also includes a second play take-up member between the second slideway 181 and the second slide member 161.

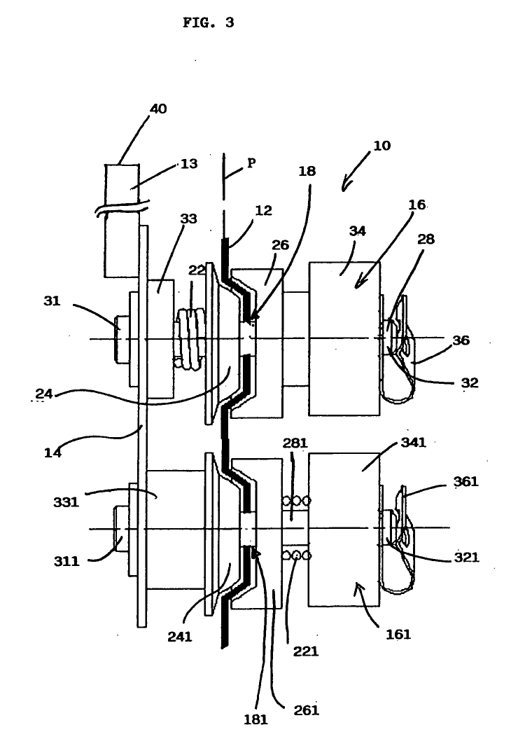

FIG. 3 is a diagrammatic view of the profile of window regulator 10 of FIG. 1. The second slide member 161 can include the same parts as the slide member 16 described above between the ends 311 and 321. Possible parts include a pin 281, a shoulder 331, jaws 241 and 261 embracing the slideway 181, a cross-member 341, and a circlip 361 that prevents translational movement of the complete assembly. A second play take-up member 221 is preferably mounted coaxially with the pin 281. Preferably, the second play take-up member 221 is located on the side of the slideway 181 opposite to the side facing the window glass support plate 14. The second play take-up member 221 does not extend beyond the slideway 181 in the direction of the side of the slideway 181 facing the window glass support plate 14. The second play take-up member 221 allows the jaws 241 and 261 to be urged towards each other to ensure sliding contact between the second slide member 161 and the second slideway 181 and to take up play resulting from assembly (i.e., manufacturing tolerance) and from wear of the second slide member 161. The two slideways 18 and 181 can both be provided in the panel 12 and in the same mean plane P. The panel 12 makes the window regulator 10 more rigid and easier to assemble into the vehicle.

As shown in FIG. 3, the outside of the vehicle is located on the side of the mean plane P of the panel 12 occupied by the window glass 13, and the other side of the mean plane P faces the inside of the vehicle. The panel 12 has two slideways 18 and 181, and one slide member 16 and 161 slides in each of the two slideways 18 and 181, respectively. When the window regulator 10 is fitted into the vehicle, the slide member 16 is situated above the slide member 161. The play take-up members 22 and 221 are each on one side of the mean plane P and do not extend away at the other side of the mean plane P. The play take-up member 22 for the slide member 16 is located between the window glass support plate 14 and the slideway 18. The second play take-up member 221 for the second slide member 161 is located at the side of the mean plane P that faces the inside of the vehicle and does not face the window glass support plate 14.

When the window regulator 10 and the window glass 13 are mounted in the vehicle, the window glass 13 is held in cantilevered fashion by the window regulator 10. Thus, when the window glass 13 is urged toward the outside of the vehicle, the top edge 40 of the window glass 13 swings toward the ground. The swinging of the top edge 40 of the window glass 13 urges the second slide member 161 toward the inside of the vehicle, urging the slide member 16 toward the outside of the vehicle. Nevertheless, because both of the play take-up members 22 and 221 are at one side of the mean plane P of the panel 12, the slide members 16 and 161 each abut against the panel 12 from one side, and no forces are applied to the play take-up members 22 and 221. The end 32 of the slide member 16 abuts against the panel 12, and the end 311 of the second slide member 161 abuts against the panel 12. The distance between the window glass support plate 14 and the two slideways 18 and 181, and consequently the distance between the window glass 13 and the panel 12, both remain substantially constant when the window glass 13 is at half its path of travel. The two slide members 16 and 161 now prevent the top edge 40 of the window glass 13 from deviating from its normal path, thereby ensuring that the top edge 40 of window glass 13 correctly penetrates the vehicle roof seal.

The invention also relates to a vehicle carrying a window regulator 10. While the vehicle is running with the window half open, the top edge 40 of the window glass 13, which is held in cantilevered fashion by the window regulator, does not swing, allowing the window glass 13 to be completely raised while the vehicle is running and ensuring that the top edge 40 of the window glass 13 correctly penetrates into the roof seal. In particular, the rigidity of the window glass 13 with response to the outside of the vehicle is ensured with the window regulator 10 described above, which includes the first slide member 16, with the play take-up member 22 located between the slideway 18 and the window glass support plate 14, that is located above the second slide member 161, with the second play take-up member 221 arranged at the other side of the panel 12 with respect to the play take-up member 22.

Obviously, the present invention is not limited to the embodiments described by way of example. Thus, the window lifter is not limited to use with a rear side window of a Cabriolet or coupe type vehicle, but can be used on a front window and on any type of vehicle. Further, the invention is not limited to the use of the jaws 24 and 26 described to ensure the slide members 16 and 161 are suitably retained inside the respective slideways 18 and 181. Further, the invention is not limited to the cross-section profile of the slideway 18 and 181 or to the described profile for the jaws 24 and 26.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A vehicle window regulator comprising:
a window glass support plate;
a slide member for driving said window glass support plate;
a slideway for guiding said slide member; and
a play take-up member for taking up play between said slide member and said slideway, wherein said play take-up member is arranged between said window glass support plate and said slideway.

2. The vehicle window regulator according to claim 1, wherein said slide member comprises two jaws embracing the slideway.

3. The vehicle window regulator according to claim 2, wherein said two jaws are urged toward each other by said play take-up member.

4. The vehicle window regulator according to claim 2, wherein a jaw shape of said two jaws matches a slideway shape of said slideway in a direction transverse to a length of said slideway.

5. The vehicle window regulator according to claim 2, wherein said slideway includes a slot and opposing sides and the slide member includes a pin extending through said slot in said slideway, wherein each of said two jaws are slidable along one of said opposing sides of said slideway, and wherein said pin is slidable along said slideway.

6. The vehicle window regulator according to claim 5, wherein said play take-up member is a spring that is coaxial with said pin.

7. The vehicle window regulator according to claim 1, further comprising a second slide member for driving said window glass support plate.

8. The vehicle window regulator according to claim 7, further comprising:
a second slideway for guiding said second slide member; and
a second play take-up member located between said second slideway and said second slide member.

9. The vehicle window regulator according to claim 8, wherein said slideway and said second slideway are in a common plane, and wherein the play take-up member and the second play take-up member are both located on a common side of said common plane.

10. A vehicle door comprising:
a window glass; and
a window regulator comprising:
a window glass support plate, movement of said window glass support plate moving said window glass;
a slide member for driving said window glass support plate;
a slideway for guiding said slide member; and
a play take-up member for taking up play between said slide member and said slideway, wherein said play take-up member is arranged between said window glass support plate and said slideway.

11. The vehicle door according to claim 10, wherein said window regulator further comprises a second slide member for driving said window glass support plate, and wherein said slide member is located above said second slide member.

12. The vehicle door according to claim 11, further comprising:
a second slideway for guiding said second slide member; and
a second play take-up member located between said second slideway and said second slide member.

13. The vehicle door according to claim 12, wherein said slideway and said second slideway are in a common plane, and wherein said play take-up member and said second play take-up member are both located on a common side of said common plane.
